(19) United States
(12) Patent Application Publication
(10) Pub. No.: US 2026/0110275 A1
(43) Pub. Date: Apr. 23, 2026

(54) ENGINE SYSTEM

(71) Applicant: CUMMINS INC., Columbus, IN (US)

(72) Inventors: Abhyas Kumar Singh, Pune (IN); Govind Trimbakrao Phad, Gangakhed (IN); Arun Jyoti Pathak, Tezpur (IN); Darshana Tipale, Pune (IN); Abhin Vijayan, Thiruvananthapuram (IN); Sudhir Dharamshale, Balewadi (IN); Krishna Mohan Rai, Gopalganj (IN)

(73) Assignee: CUMMINS INC., Columbus, IN (US)

(21) Appl. No.: 19/358,766

(22) Filed: Oct. 15, 2025

(30) Foreign Application Priority Data
Oct. 22, 2024 (IN) 202441080107
Sep. 23, 2025 (IN) 202441080107

(51) Int. Cl. F02F 7/00

(52) U.S. Cl. CPC F02F 7/0021; F02F 7/0007

(57) ABSTRACT

An engine system comprising a cylinder block and a plate. The cylinder block comprises a plurality cylinders, each cylinder of the plurality of cylinders defining a cylinder axis. The plate is coupled to the cylinder block proximate a subset of cylinders of the plurality of cylinders, the subset of cylinders having fewer than a total amount of cylinders in the plurality cylinders. The plate comprises a plate body defining a plurality of openings. Each opening of the plurality of openings is aligned with a corresponding cylinder of the subset of cylinders such that, for each opening of the plurality of openings, the cylinder axis of the corresponding cylinder extends through the opening.

### CROSS-REFERENCE TO RELATED APPLICATIONS

The present application claims priority to Indian Provisional Patent Application No. 202441080107, filed Oct. 22, 2024 and the contents of which are incorporated herein by reference.

### FIELD

The present application generally relates to engine systems.

### BACKGROUND

During operation of an internal combustion engine, fuel is combusted to rotate an output shaft (e.g., a crankshaft, etc.). When the fuel is combusted, the force of the combustion can result in mechanical stresses acting on the cylinder block of the engine.

### SUMMARY

One embodiment of the invention relates to an engine system. The engine system includes a cylinder block having a plurality cylinders. Each cylinder of the plurality of cylinders defines a cylinder axis. The engine system includes a plate coupled to the cylinder block proximate to a subset of cylinders of the plurality of cylinders. The subset of cylinders having fewer than a total amount of cylinders in the plurality cylinders. The plate includes a plate body defining a plurality of openings. Each opening of the plurality of openings is aligned with a corresponding cylinder of the subset of cylinders such that, for each opening of the plurality of openings, the cylinder axis of the corresponding cylinder extends through the opening.

### BRIEF DESCRIPTION OF THE DRAWINGS

FIG. 1 is a bottom view showing a portion of an engine system, according to an example embodiment.

FIG. 2 is a bottom view of a plate of the engine system shown in FIG. 1.

FIG. 3 is a schematic block diagram of an example engine system in accordance with the arrangement of FIG. 1.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

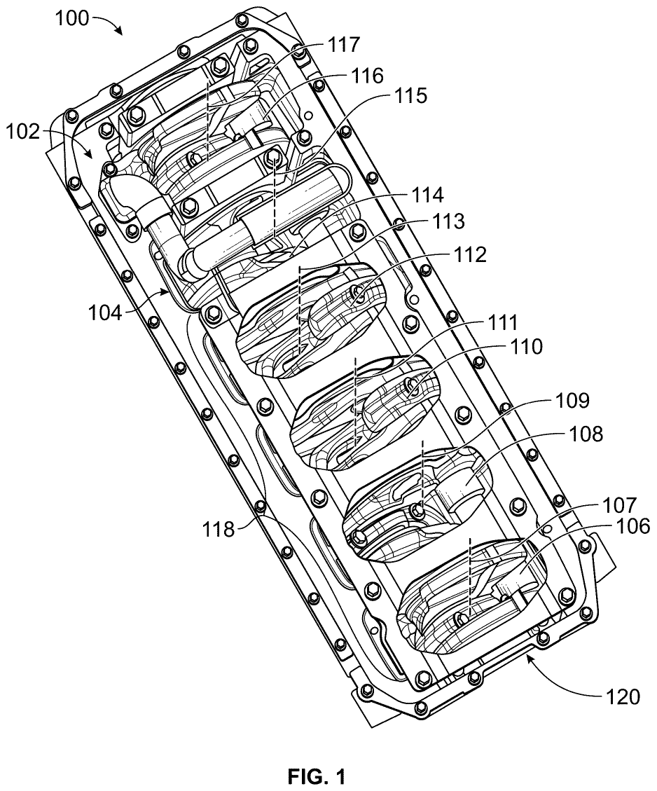

As represented and shown in FIGS. 1-3, an engine system 100 includes a cylinder block 102. The cylinder block 102 includes a plurality of cylinders 104. Each cylinder of the plurality of cylinders 104 defines a cylinder axis. The engine system 100 includes a plate 120 coupled to the cylinder block 102 proximate a subset of cylinders 118 of the plurality of cylinders 104. The subset of cylinders 118 has fewer than a total amount of cylinders in the plurality of cylinders 104. The plate 120 includes a plate body 122 defining a plurality of openings 134. Each opening of the plurality of openings 134 is aligned with a corresponding cylinder of the subset of cylinders 118 such that, for each opening of the plurality of openings 134, the cylinder axis of the corresponding cylinder extends through the opening.

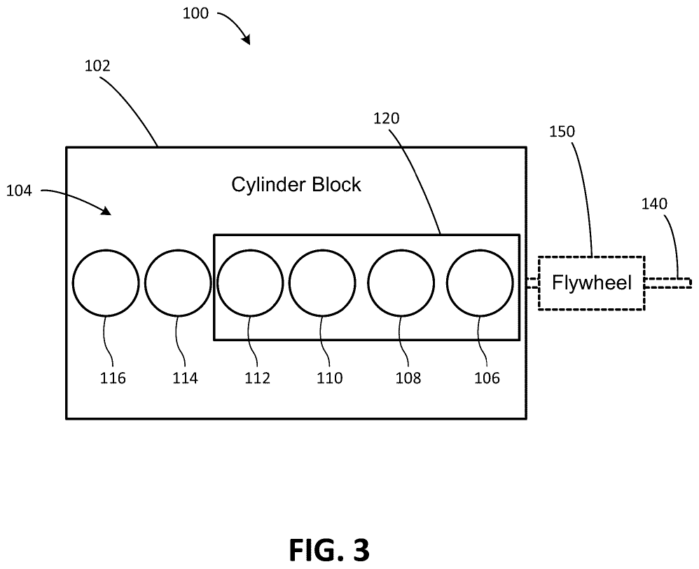

In some embodiments, the engine system 100 is a diesel internal combustion engine system. The diesel internal combustion engine system is configured to combust diesel fuel to generate power. During operation, fuel is combusted in the cylinders 104, and the force of the combustion can result in mechanical stress acting on the cylinder block 102. Advantageously, the plate 120 is coupled to the cylinder block 102 to mitigate deformation of the cylinder block 102 due to the mechanical stress imparted on the cylinder block due to combustion of fuel within the cylinders 104. As shown in FIGS. 1 and 3, the plate 120 is positioned proximate the first end of the cylinder block 102. This arrangement allows the plate 120 to sufficiently mitigate deformation of the cylinder block 102 while minimizing the size (e.g., mass, volume, or both) of the plate 120.

In the embodiment shown in FIGS. 1 and 3, the plurality of cylinders 104 includes six cylinders, shown as a first cylinder 106, a second cylinder 108, a third cylinder 110, a fourth cylinder 112, a fifth cylinder 114, and a sixth cylinder 116. As shown, the cylinders 104 are arranged in an in-line configuration. The first cylinder 106 is positioned at or proximate a first end of the cylinder block 102. The sixth cylinder 116 is positioned at or proximate a second end of the cylinder block 102, opposite the first end of the cylinder block. 102.

Bach cylinder of the plurality of cylinders 104 defines cylinder axis. The first cylinder 106 defines a first cylinder axis 107. The second cylinder 108 defines a second cylinder axis 109. The third cylinder 110 defines a third cylinder axis 111. The fourth cylinder 112 defines a fourth cylinder axis 113. The fifth cylinder 114 defines a fifth cylinder axis 115. The sixth cylinder 116 defines a sixth cylinder axis 117.

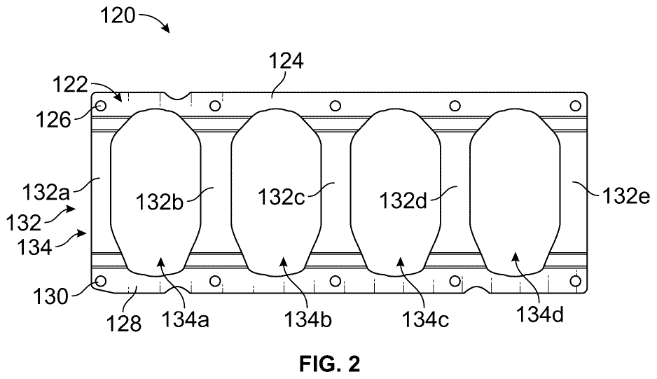

As shown in FIG. 2, the plate body 122 includes a first plate portion 124 and a second plate portion 128. The second plate portion is spaced away from the first plate portion 124. The plate body 122 includes a plurality of ribs 132 that extend between the first plate portion 124 and the second plate portion 128 such that a corresponding opening of the plurality of openings 134 is defined between adjacent ribs of the plurality of ribs 132.

The first plate portion 124 defines one or more first apertures 126. The one or more first apertures 126 are each sized to receive a fastener therein. The fastener is positionable through the one or more first apertures 126, such that the fastener can couple the plate body 122 to the cylinder block 102.

The second plate portion 128 defines one or more second apertures 130. The one or more. second apertures 130 are each sized to receive a fastener therein. The fastener is positionable through the one or more second apertures 130, such that the fastener can couple the plate body 122 to the cylinder block 102.

The plate body 122 includes the plurality of ribs 132. As shown in FIG. 2, the plurality of ribs 132 includes five ribs, shown as a first rib 132a, a second rib 132b, a third rib 132c, a fourth rib 132d, and a fifth rib 132e. The plate body 122 defines four openings, shown as a first opening 134a, a second opening 134b, a third opening 134c, and a fourth opening 134d. The first opening 134a is defined between the first rib 132a and the second rib 132b. The second opening 134b is defined between the second rib 132b and the third rib 132c. The third opening 134c is defined between the third rib 132c and the fourth rib 132d. The fourth opening 134d is defined between the fourth rib 132d and the fifth rib 132e.

The plurality of openings 134 defined within the plate body 122 can take a variety of shapes. The shape of each opening 134 may be the same as or different from the shape of one more of the other openings 134. Additionally, the cross-sectional area of each opening 134 may be the same as or different from than the cross-sectional area of one or more of the other openings 134.

Using the first opening 134a of FIG. 2 for reference, each of the plurality of openings 134 may include a first side 136a and a second side 136b substantially parallel to the first side 136a. As shown in FIG. 2, each of the first side 136a and the second side 136b are substantially straight. In other embodiments, however, one or both of the first side 136a and the second side 136b may include a curvature or are otherwise may not be substantially straight.

The first side 136a and the second side 136b each extend between a first end 136c and a second end 136d. As shown in FIG. 2, the first end 136c and the second end 136d are curved. However, one or both of the first end 136c and the second end 136d may not possesses a curvature. Additionally, a curvature of the first end 136c may differ from a curvature of the second end 136d.

In the embodiment depicted in FIG. 2, each opening 134 includes a plurality of linking portions 136e, each of which links one of the first side 136a or the second side 136b with one of the first end 136c or the second end 136d. Each linking portion 136e may be straight or curved, and a curvature of one linking portion 136e may differ from the curvature of another linking portion 136e.

As shown in FIGS. 1 and 3, the plate 120 is coupled to the cylinder block 102 at a first end of the cylinder block 102, such that the first opening 134a of the plurality of openings 134 is aligned with the first cylinder 106 of the plurality of cylinders 104. As described above, the first cylinder 106 is positioned proximate the first end of the cylinder block 102.

The subset of cylinders 118 includes four cylinders of the plurality of cylinders 104. As shown in FIG. 1, the subset of cylinders 118 includes the first cylinder 106, the second cylinder 108, the third cylinder 110, and the fourth cylinder 112. Accordingly, the first opening 134a is aligned with the first cylinder 106, such that the first cylinder axis 107 extends through the first opening 134a. The second opening 134b is aligned with the second cylinder 108, such that the second cylinder axis 109 extends through the second opening 134b. The third opening 134c is aligned with the third cylinder 110, such that the third cylinder axis III extends through the third opening 134c. The fourth opening 134d is aligned with the fourth cylinder 112, such that the fourth cylinder axis 113 extends through the fourth opening 134d.

FIG. 3 shows additional components (in dashed lines) which may be included with the engine system 100. For example, the engine system 100 can include one or more of a crankshaft 140 or a flywheel 150.

The crankshaft 140 is operatively coupled to the engine. During operation of the engine, combustion of fuel within the cylinders 104 causes rotation of the crankshaft 140.

As shown in FIG. 3, the flywheel 150 is positioned at or proximate the first end of the cylinder block 102 (e.g., proximate the first cylinder 106). During operation of the engine, combustion of fuel within the cylinders 104 causes rotation of the flywheel 150 (e.g., via the crankshaft 140). Because the plate 120 is positioned proximate the first end of the cylinder block 102; the plate 120 is also positioned proximate the flywheel 150. The arrangement of the plate 420 coupled to the cylinder block 102 proximate the flywheel 150 may improve the vibrational characteristics of the engine system 100 by, for example, increasing the natural frequency of the cylinder block 102.

In some embodiments, the plate 120 is formed by a metal stamping process. In some embodiments, the plate body 122 includes a metallic material, such as steel, or, more specifically, a low-carbon steel.

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two. components of the two components and any additional intermediate components being integrally formed as a single unitary body with one another, with the two components, or with the two components and any additional intermediate components being attached to one another.

It is important to note that the construction and arrangement of the various systems shown in the various example implementations is illustrative only and not restrictive in character, All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

References herein to the positions of elements (e.g., “top,” “bottom,” “above,” “below,” “left,” “right”) are merely used to describe the orientation of various elements in the FIGURES. It should be noted that the orientation of various elements may differ according to other exemplary embodiments, and that such variations are intended to be encompassed by the present disclosure.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z; Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

What is claimed is:

1. An engine system comprising:
a cylinder block comprising a plurality of cylinders, each cylinder of the plurality of cylinders defining a cylinder axis; and
a plate coupled to the cylinder block proximate a subset of cylinders of the plurality of cylinders, the subset of cylinders having fewer than a total amount of cylinders in the plurality of cylinders, the plate comprising a plate body defining a plurality of openings, each opening of the plurality of openings aligned with a corresponding cylinder of the subset of cylinders such that, for each opening of the plurality of openings, the cylinder axis of the corresponding cylinder extends through the opening.

2. The engine system of claim 1, wherein the plate is coupled to the cylinder block at a first end of the cylinder block such that a first opening of the plurality of openings is aligned with a first cylinder of the plurality of cylinders, the first cylinder is positioned proximate the first end of the cylinder block.

3. The engine system of claim 2, further comprising a flywheel positioned proximate the first end of the cylinder block.

4. The engine system of claim 1, wherein the plate body comprises:
a first plate portion;
a second plate portion; and
a plurality of ribs extending between the first plate portion and the second plate portion such that a corresponding opening of the plurality of openings is defined between adjacent ribs of the plurality of ribs.

5. The engine system of claim 1, wherein the plurality of cylinders comprises six cylinders.

6. The engine system of claim 2, wherein the plurality of openings comprises four openings.

7. The engine system of claim 1, wherein the plurality of cylinders are arranged in an in-line configuration.

8. The engine system of claim 1, wherein each opening of the plurality of openings possesses a substantially same shape as each other opening of the plurality of openings.

9. The engine system of claim 1, wherein each opening of the plurality of openings is defined by:
a first end;
a second end;
a first side extending between the first end and the second end; and
a second side substantially parallel to the first side and extending between the first end and the second end.

10. The engine system of claim 9, wherein the first side and the second side are substantially straight.

11. The engine system of claim 10, wherein the first end and the second end are curved.

12. The engine system of claim 11, wherein each opening of the plurality of openings is further defined by a plurality of linking portions, each of the plurality of linking portions linking one of the first end or the second end with one of the first side or the second side.

13. The engine system of claim 1, wherein each opening of the plurality of openings possesses a substantially cross-sectional area as each other opening of the plurality of openings.
